(19) United States
(12) Patent Application Publication
(10) Pub. No.: US 2015/0377837 A1
(43) Pub. Date: Dec. 31, 2015

(54) Ultrasonic sensor for object and movement detection

(71) Applicant: The Board of Trustees of the Leland Stanford Junior University, Palo Alto, CA (US)

(72) Inventors: Nikhil Prakash Apte, Mountain View, CA (US); Jung Woo Choe, Sunnyvale, CA (US); Anshuman Bhuyan, Milpitas, CA (US); Amin Nikoozadeh, Palo Alto, CA (US); Butrus T. Khuri-Yakub, Palo Alto, CA (US)

(21) Appl. No.: 14/843,644

(22) Filed: Sep. 2, 2015

Related U.S. Application Data
(63) Continuation-in-part of application No. 14/100,398, filed on Dec. 9, 2013.
(60) Provisional application No. 62/044,656, filed on Sep. 2, 2014.
(60) Provisional application No. 61/768,050, filed on Feb. 22, 2013.

(51) Int. Cl. G01N 29/24

(52) U.S. Cl. CPC G01N 29/2406; G01N 2291/101; G01N 2291/044

(57) ABSTRACT

We provide arrays of capacitive micromachined ultrasonic transducer (CMUT) elements having large fractional bandwidth and configured such that each array element operates both to transmit and to receive. Large fractional bandwidth is provided by venting the CMUT cavity, which provides an additional source of damping for the resonant CMUT.

### CROSS-REFERENCE TO RELATED APPLICATIONS

This application claims the benefit of U.S. provisional patent application 62/044,656, filed on Sep. 2, 2014, and hereby incorporated by reference in its entirety.

This application is a continuation in part of U.S. Pat. No. 14/100,398, filed on Dec. 9, 2013, and hereby incorporated by reference in its entirety.

Application Ser. No. 14/100,398 claims the benefit of U.S. provisional application 61/768,050, filed on Feb. 22, 2013, and hereby incorporated by reference in its entirety.

### FIELD OF THE INVENTION

The present invention relates generally to Capacitive Micromachined Ultrasound Transducers (CMUTs). More particularly, the invention relates to CMUTs with pressurized cavities for operating in environments with extreme pressure variations.

### BACKGROUND

Capacitive Micromachined Ultrasound Transducers (CMUTs) are increasingly being considered as a better alternative to traditional piezoelectric ultrasound transducers. In airborne applications, CMUTs offer the advantage of better impedance matching to the medium than piezoelectric transducers. One such application for CMUTs is in transit-time ultrasound flowmeters used for flare gas metering. Flare gas metering presents unique challenges due to the large variation in the flow velocities, gas pressures and gas composition. Ultrasound flowmeters are ideal for use in this application. However conventional CMUTs with vacuum backed plates cannot be used under widely varying ambient pressures. The pressure differential across the plate changes the static deflection of the plate, and as a result, the electric field through the gap. In a varying ambient pressure, the transmit and receive sensitivities and the operating frequency would vary considerably. Beyond a certain pressure, the CMUT plates would collapse onto the substrate and would drastically change their operating frequency.

In one attempt to address this problem, one group proposed operating CMUTs in a permanent contact mode even under 1 atm pressure. This would enable a more stable operating point over a wider operating pressure range. However, even such a CMUT would still be limited by the mechanical strength of the structure. Beyond a certain pressure, such a CMUT would fail mechanically.

What is needed is a CMUT that is capable of operating in environments ranging from relatively low pressure to several atmospheres of pressure.

### SUMMARY

To address the needs in the art, a capacitive micromachined ultrasonic transducer (CMUT) is provided that includes a substrate, a bottom conductive layer disposed on a bottom surface of the substrate, a cavity disposed into a top surface of the substrate, a nonconductive layer disposed on the substrate top surface and on the cavity, a CMUT plate disposed on the nonconductive layer and across the cavity, a top conductive layer disposed on a top surface of the CMUT plate, a pressure control via that spans from the cavity to an ambient environment, and an active pressure controller connected to the pressure control via, wherein the active pressure controller is capable of actively varying a pressure differential across the CMUT plate.

In one aspect of the invention, the CMUT plate is capable of operating at multiple resonance modes, where the resonance modes are a result of the interaction between the resonant mode of the plate and the acoustic resonance in the medium of the cavity and vias.

In a further aspect of the invention, the pressure control via spans from the cavity through the bottom conductive layer, or from the cavity through the CMUT plate.

According to another aspect of the invention, the active pressure controller is capable of controlling the signal gain of the CMUT, the signal bandwidth of the CMUT, or the signal gain and the signal bandwidth of the CMUT.

In another aspect of the invention, the signal gain and signal bandwidth of the CMUT are determined by parameters that include the size of the CMUT, the shape of the CMUT, the location of the pressure control vias and the number of the pressure control vias.

In a further aspect of the invention, arrays of vented CMUT elements are provided where each array element is configured to both transmit and receive.

### BRIEF DESCRIPTION OF THE DRAWINGS

FIGS. 1A-1H show a fabrication process flow for CMUTs with vented cavities, according to one embodiment of the invention.

FIGS. 2A-2D show different arrangements of vias to vent CMUT cavity, according to embodiments of the invention.

FIGS. 3A-3B show individual vented CMUT dies mounted on chip carriers with drilled recesses, according to one embodiment of the current invention.

FIG. 4 shows a graph of two resonance modes by the CMUT, where the effect of via arrangement on CMUT's frequency response spectrum (Plate radius=750 μm, plate thickness=10 μm, gap height=11.2 μm, via radius=20 μm, via length=500 μm), according to one embodiment of the current invention.

FIG. 5 shows as the plate radius is increased, the acoustic (Helmholtz) resonance dominated mode becomes stronger than the plate dominated mode, where the effect of plate radius on CMUT's frequency response spectrum (Plate thickness=10 μm, gap height=11.2 μm, via radius=20 μm, via length=500 μm, vias in type-2 arrangement), according to one embodiment of the invention.

FIG. 6 shows the effect of plate radius on the acoustic (Helmholtz) resonance dominated mode frequency (Plate thickness=10 μm, gap height=11.2 μm, via radius=20 μm, via length=500 μm), according to one embodiment of the invention.

FIGS. 7A-7B show graphs of a pitch-catch signal (Plate radius=750 μm, plate thickness=20 μm, gap height=5.6 μm, via radius=20 μm, via length=500 μm, pressure=15 bar, DC bias=300 V), according to embodiments of the invention.

FIGS. 8A-8D show embodiments of the invention relating to arrays of vented CMUTs.

### DETAILED DESCRIPTION

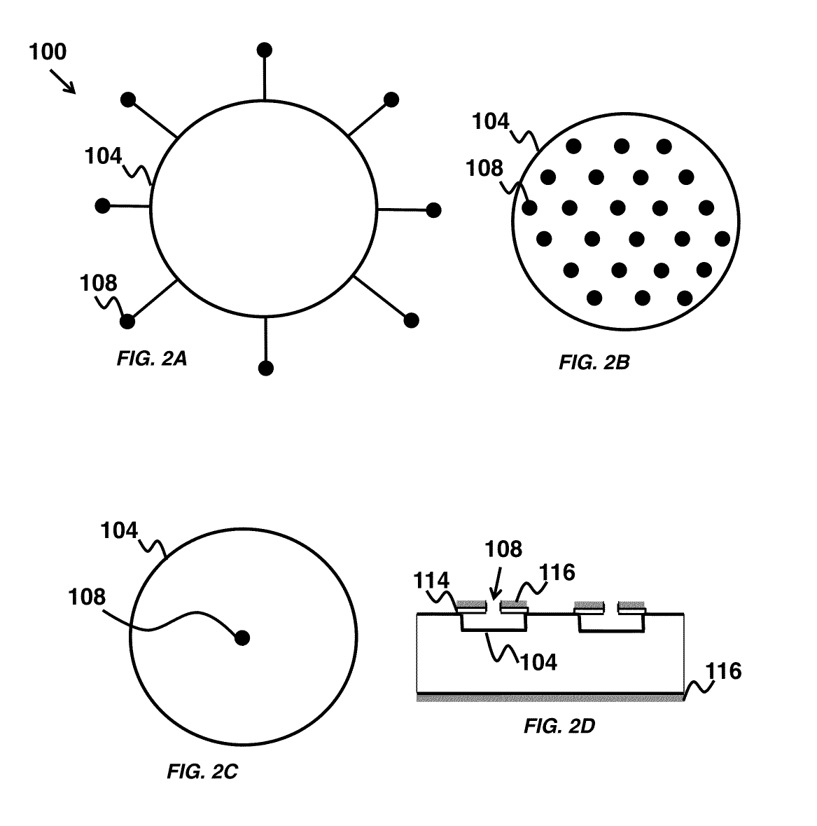

The current invention includes venting the cavities of CMUTs for environments with extreme pressure variations. In one embodiment, the CMUT has zero differential pressure across the plate at any ambient pressure, thus ensuring a stable operating point and preventing mechanical failure. The venting vias are etched through the substrate or throught the CMUT plate (see FIG. 2D). In one exemplary embodiment, two resonances are observed from the vented CMUTs—the mechanical resonance of the plate and an acoustic Helmholtz resonance associated with the cavity and the venting vias. Examples are provided of a variety of fabricated CMUTs having varied plate radii, thicknesses, gap heights and via arrangements to study these two resonances. In one example, a pair of CMUTs were characterized in a pitch-catch setup under varying ambient pressure. Here, the CMUTs were successfully able to transmit and receive ultrasound under an ambient pressure of up to 20 bar. As the pressure increases, the plate resonance dominated mode becomes weaker while the Helmholtz resonance dominated mode becomes stronger. The Helmholtz resonance dominated mode maintains its frequency and bandwidth under varying ambient pressure.

A CMUT cavity vented to the ambient environment ensures a zero differential pressure across the plate, and provides a stable operating point for the CMUT under varying ambient pressure. Also, with no pressure across the plate, such a CMUT is able to operate under any pressure condition with no risk of mechanical damage or failure.

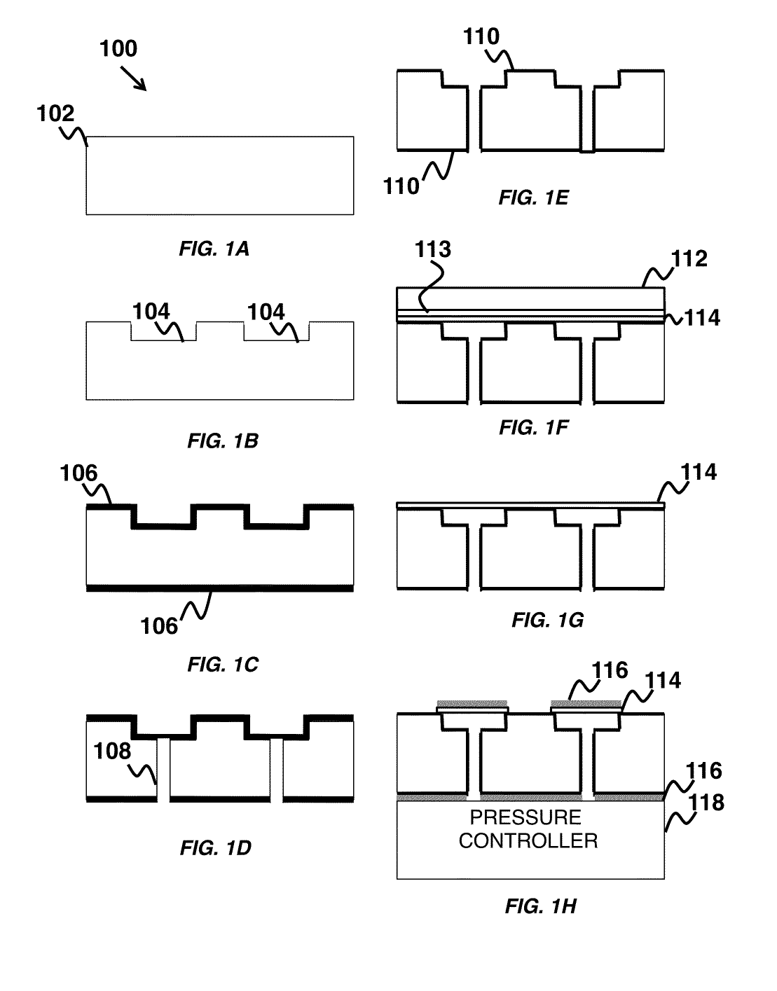

According to embodiments of the current invention, the CMUT cavity is vented by etching via holes through the CMUT plate or through the substrate. According to one embodiment, the fabrication process for the CMUT 100 starts with a low resistivity silicon wafer 102 (see FIG. 1A). The wafer 102 is patterned and cavities 104 are etched in the silicon 102 using wet TMAH (Tetra methyl Ammonium Hydroxide) (see FIG. 1B). The wet TMAH etch has good uniformity across the wafer and the etch depth can be controlled quite accurately after the etch rate is characterized for the setup. A thermal oxide layer 106 is applied to the top surface and bottom surface of the etched silicon wafer 102 (see FIG. 1C). The wafer is patterned on the backside and through-wafer vias 108 are etched from the back using deep reactive ion etching (DRIE) (see FIG. 1D). The oxide used as the masking layer is then stripped and 1.5-μm thick thermal oxide is grown again as an insulation layer 110 as well as for oxide posts for bonding (see FIG. 1E). A plate SOI wafer having handle layer 112, buried oxide layer 113 and silicon layer 114 is then bonded on top using direct fusion bonding (see FIG. 1F) and annealed in nitrogen at 1050° C. for 4 hours. The handle layer 112 and the buried oxide layer 113 of the plate SOI wafer are then etched away to release the CMUT plates 114 (see FIG. 1G). A 500-nm thick layer of aluminum 116 is evaporated on the front and back of the wafer to provide better electrical contact. The aluminum and plate silicon is then patterned to define each transducer unit (element), where the vias are also connected to a pressure controller 118 (see FIG. 1H).

The signal gain and signal bandwidth of the CMUT are determined by parameters that include the size of the CMUT, the shape of the CMUT, the location of the pressure control vias and the number of the pressure control vias.

In some exemplary embodiments, a variety of CMUTs were fabricated using this process by varying the plate thickness, plate radius and gap height. The dimensions of the vias were kept the same for ease of fabrication however the number of vias and the arrangement of these vias were varied as shown in FIGS. 2A-2D.

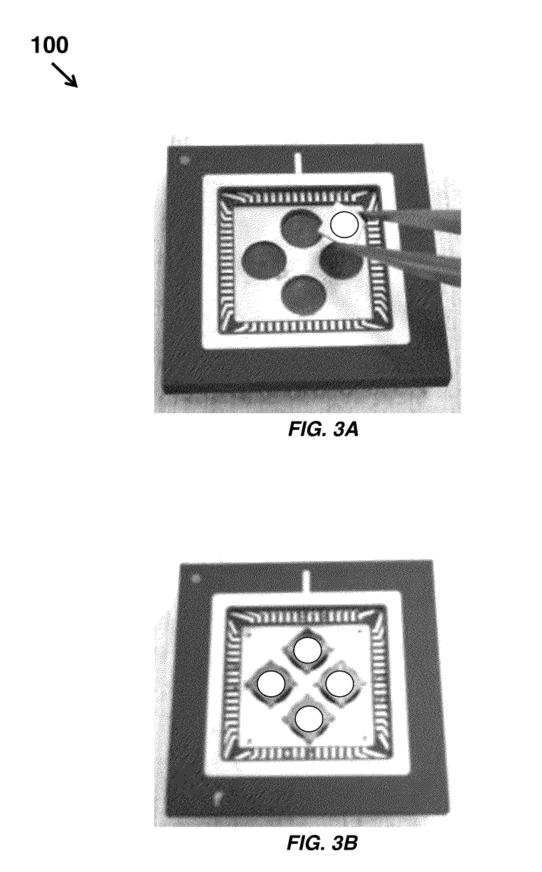

The fabricated CMUTs 100 were singulated by dicing, mounted on chip carriers and wirebonded (see FIGS. 3A-3B). Small recesses were drilled in the chip carriers so as to connect the via holes to ambient air. The CMUTs with vented cavities inherently have two resonances. The first resonance is dominated by the CMUT plate with its associated mass and stiffness, loaded by the air medium on top and backed by a squeeze film of the gas/fluid in the cavity. The second resonance is made up of the gas/fluid inside the via and CMUT cavity which form an acoustic Helmholtz resonator-like structure. The effective response of the CMUT is a result of the interaction between these two resonances.

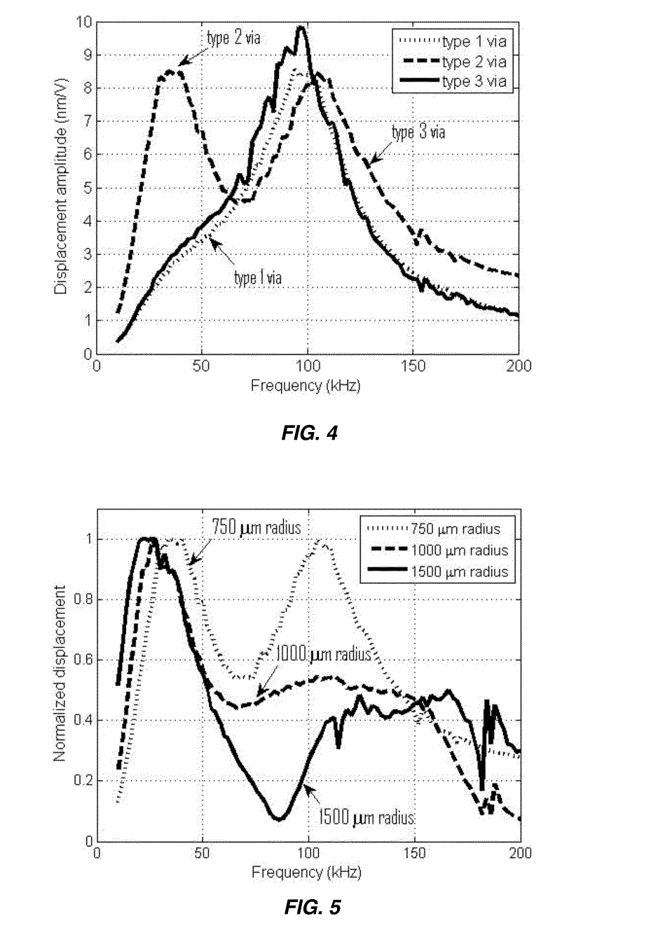

In an exemplary embodiment, the CMUTs were initially characterized under 1 atm pressure. The CMUTs were biased with a DC voltage and excited with an AC voltage while sweeping the frequency. The displacement amplitude was measured under a laser Doppler vibrometer (LDV; OFV-511, Polytec GmbH, Waldbronn, Germany). As expected, the CMUTs exhibit two resonant modes (see FIG. 4). The plate dominated resonant mode is unaffected by the number of venting vias or their arrangement. However the Helmholtz resonance dominated mode is strongly dependent on the number of vias and becomes stronger as more vias are used. The frequency of the Helmholtz mode is independent of the number of vias or their arrangement.

Keeping all other parameters the same, as the plate radius is increased, the Helmholtz dominated mode becomes stronger than the plate dominated mode (see FIG. 5). Despite the decrease in the plate stiffness the frequency of the plate dominated mode increases slightly. This could be due to increased stiffness from the squeeze film.

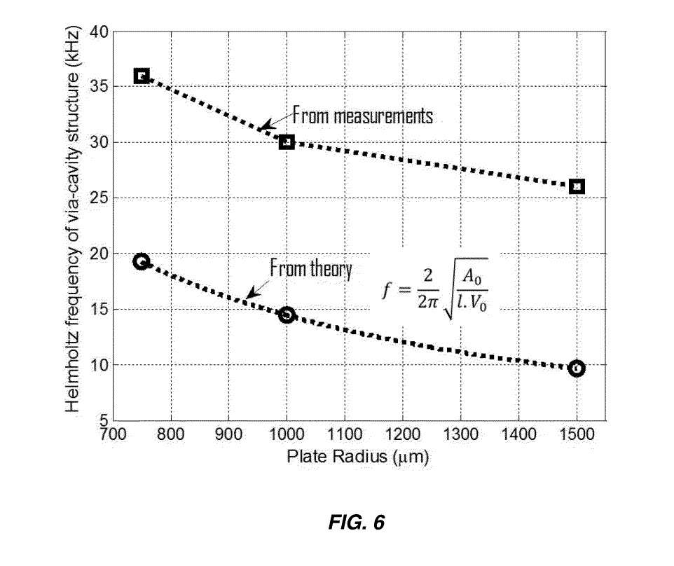

The frequency of the Helmholtz dominated mode decreases as the plate radius is increased. This trend conforms to the theoretical frequency for a pure Helmholtz resonator of similar dimensions (see FIG. 6).

In another exemplary embodiment, a pair of identical devices was arranged in a pitch-catch setup in a pressure chamber at a distance of 7 cm from each other. Since these CMUTs have a relatively large bandwidth, the short circuit resonance frequency of the transmitting CMUT and the open circuit resonance frequency of the receiving CMUT need not be matched perfectly by adjusting the bias voltage.

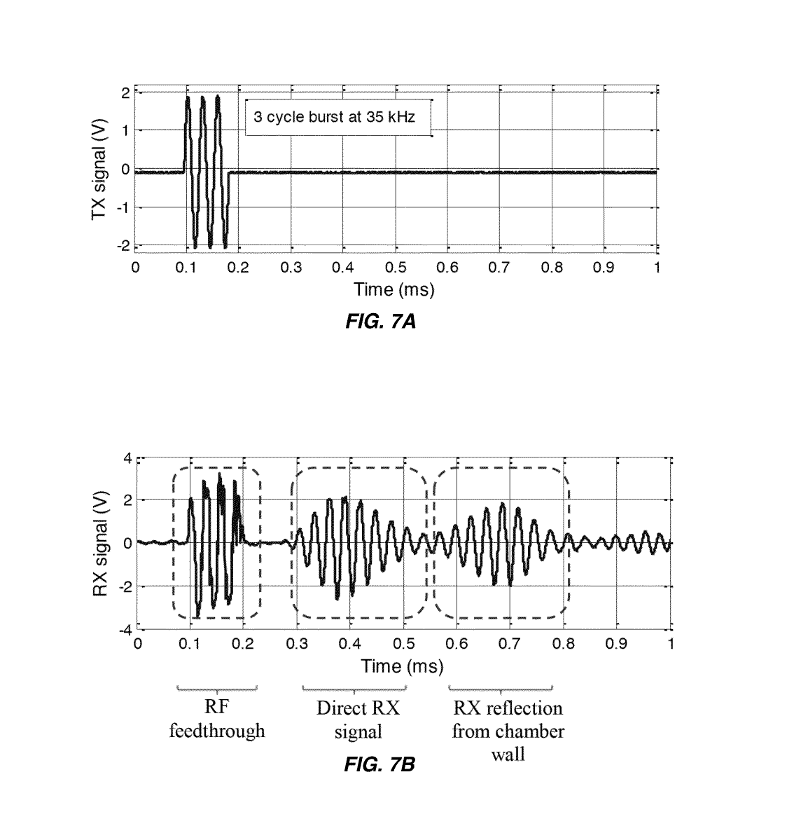

Ideally both the CMUTs can be biased closer to their collapse voltage to optimize the transmitting and receiving sensitivity. For this example, both the transmitting and receiving CMUT were biased at 300 V (˜65% of collapse). The bias voltage was limited to protect the devices against any dielectric breakdown. The wider bandwidth of these CMUTs allows for a shorter transmit burst signal. In this case, the transmitting CMUT was excited by a 3 cycle AC burst and the signal from the receiving CMUT was recorded (see FIGS. 7A-7B). The frequency of the transmit burst signal was varied to get the frequency spectrum of the pitch-catch measurement.

The pressure in the chamber was varied from 1.01 bar (1 atm) up to 20 bar and the frequency spectrum of the pitch-catch signal was studied. At lower pressure the devices show a stronger signal at the plate dominated mode (at ˜130 kHz for this design). However as the pressure is increased, the plate dominated mode loses strength. Also its frequency and bandwidth decrease. On the contrary the Helmholtz resonance dominated mode (at ˜35 kHz for this design) becomes stronger with increasing pressure. Also, it maintains its frequency and bandwidth over the varying pressure.

Exemplary fabricated CMUTs are presented with cavities vented to the ambient atmosphere. Such CMUTs exhibit two peaks in their harmonic response, owing to the resonance of the plate and the acoustic Helmholtz resonance of the gas/fluid in the cavity and the venting via holes. The strength of the Helmholtz resonance peak strongly depends on the number of vias venting the CMUT cavity. The relative strength of the two modes also depends on the ambient pressure. With an increase in ambient pressure, the Helmholtz resonance mode becomes stronger while the plate resonance dominated mode weakens. Although its strength varies with the ambient pressure, the Helmholtz resonance mode maintains its frequency and bandwidth under varying pressure. This makes it quite attractive for use in transit-time flowmeters under varying pressure.

In another aspect of the invention, we have found vented CMUT transducers as described above to be particularly beneficial for CMUT arrays. This can be better appreciated as follows. A CMUT is a resonant system. In its simplest form it can be considered as a mechanical spring (k)—mass (m)—damper (b) system. The fractional bandwidth of this system is given by

$$FBW = \frac{b}{\sqrt{k m}}$$

The damping constant b depends on the energy loss mechanisms for the CMUT. Now, in a conventional CMUT, the energy loss occurs through ultrasound energy radiated to the medium as well as through support losses in the anchored region. When used in air, the loading from the medium is not large enough to provide enough damping to the CMUT. As a result, a conventional CMUT usually has a narrow bandwidth when used in air. This is true even for piezoelectric transducers.

Now, in case of CMUTs with vented cavities, the air inside the cavity between the moving plate and the fixed substrate forms a squeeze film. This squeeze film adds another energy loss mechanism (squeeze film damping) to the CMUT. As a result, a CMUT with a vented cavity has a much wider bandwidth. We have fabricated and characterized CMUTs with vented cavities with >35% fractional bandwidth, while conventional CMUTs typically have a fractional bandwidth of <1%.

The wide bandwidth of our transducers has many benefits. These transducers have a shorter ringdown time. The shorter ringdown time allows these transducers to have shorter pulses which improve their axial resolution. The shorter ringdown time also means that the transducer settles down quickly after transmitting ultrasound. This allows us to use the same transducer for receiving the reflected ultrasound. Also the shorter ringdown time allows to fire the transducer with a higher repetition rate, thus increasing the frame rate. Gesture sensing or ultrasound imaging in air requires accurate time-of-flight measurement. The wider bandwidth of our transducers makes it possible to determine the time-of-flight accurately using cross-correlation. Also, the wider bandwidth of these transducers makes them less prone to any device variations.

When the same transducer elements in an array are used for both transmitter and receiver, an object and movement sensor can be realized using fewer transducers than in the commercially available sensors that use separate transducers for transmit (TX) and receive (RX). The sensor system can include multiple transducers and their supporting electronics. Significant features include using wide-band transducers (CMUTs) in object and motion sensing applications, and using the same transducer for both TX and RX.

The number of transducers (N) in the system varies depending on the size of the sensor system and the resolution requirement. For a small, tablet-sized system to be used in detecting users' gestures, four transducers at the corners of the screen are sufficient. However, in order to implement a larger system such as that for a large PC monitor, or to perform more complicated jobs requiring higher accuracy such as facial recognition, the number of transducers is preferably increased.

The electronics for each transducer preferably includes a TX/RX switch and an amplifier to amplify the received signal. A TX/RX switch is used to switch between the TX and the RX modes, and separate the TX and the RX paths for each transducer that is used for both TX and RX. In the TX mode, the switch delivers the excitation pulse to the transducer, emitting the ultrasound wave. After that, it switches to the RX mode, and the ultrasound echo reflected by an object is received by the transducer. The received signal is amplified by the amplifier circuitry, and then sent to the back-end software for signal processing.

Two different schemes for data acquisition and signal processing have been considered. In a first approach, in order to achieve a high frame rate through fast sensing, all N transducers in the system are excited simultaneously, and the echo data from this simultaneous transmission are received by the same N transducers. These N signals (A-scans) acquired from a single TX/RX event are processed to find the location of the object. In a second approach, which can be used when we need higher resolution, one of the N transducers is excited and the echo data from this single-element excitation are received by all N transducers in each TX/RX event. This data acquisition is repeated N times, for each of the N transducers, to obtain the A-scan data for all TX-RX element pairs. This scheme is slower due to multiple TX/RX events per frame and a larger amount of computation in signal processing, but provides better resolution in localization and is particularly useful in applications requiring high accuracy. We developed a prototype system with four CMUTs. The prototype built on a printed circuit board (PCB) has a size of 9.56 inches by 7.47 inches, which is the same as that of a typical tablet PC. Four transducers are assembled at the four corners of the board, and are addressed by the on-board electronics for raw data acquisition.

This approach has various applications, including but not limited to: Gesture sensors for touchless operation of smartphones, tablet PCs, laptops, and desktop PCs; Proximity sensors for various applications, such as a parking sensor in a vehicle; Distance or height sensors in various applications, including unmanned aircrafts or drones; and Facial recognition sensors.

Significant advantages are provided. Higher resolution and/or accuracy can be obtained due to wider bandwidth provided by CMUT transducers. Manufacturing cost can be reduced relative to approaches that use conventional piezoelectric transducers. Using the same transducers for both TX and RX advantageously reduces the number of transducers needed.

Several variations are possible. The sensor system can be implemented with various number of transducers depending on the size of the application, for example, the size of the screen in motion-sensing applications for operating a computer. In a simple variation employing a single transducer, it can be used as a distance or proximity sensor. On the other hand, we can adopt imaging techniques in signal processing, to perform ultrasound imaging in air.

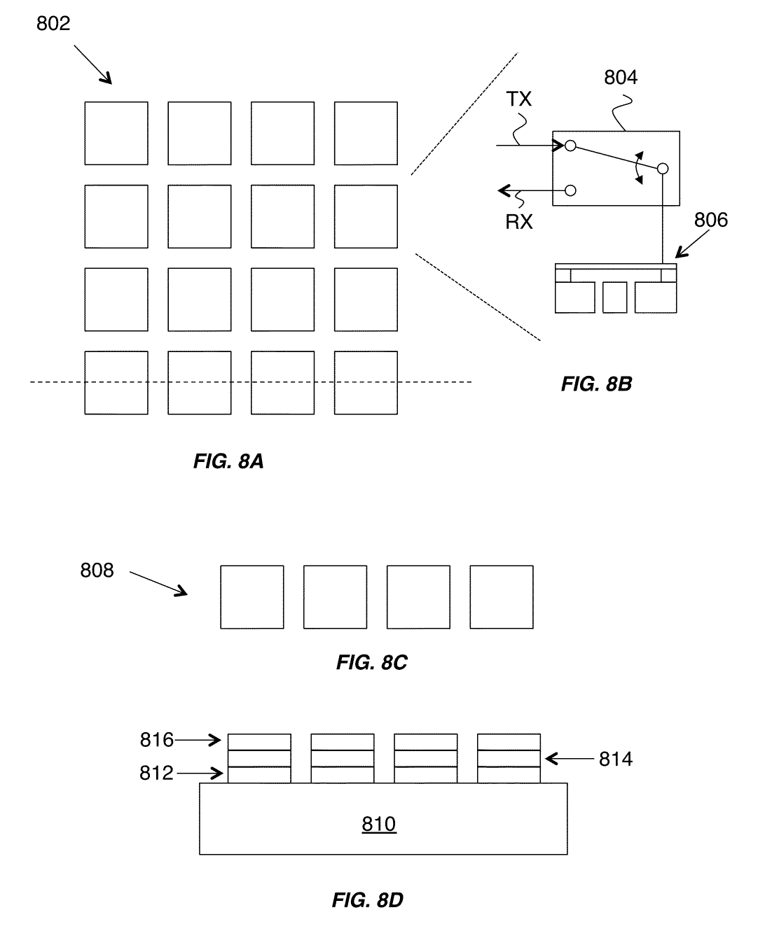

FIGS. 8A-D shows some exemplary embodiments. FIG. 8A shows a 2-D array 802 of 2 or more CMUT elements, where each CMUT element includes a CMUT plate suspended above a substrate with a cavity there between, and where the cavity of each CMUT element is vented as described above. The array is configured such that each CMUT element operates both as a transmitter and as a receiver. Preferably, the fractional bandwidth of each CMUT element is 10% or more. FIG. 8B shows a more detailed view of one of the pixels of array 802. Here 806 is the vented CMUT transducer as described above and 804 is the transmit-receive switch 804. Preferably each CMUT transducer in the array has a corresponding transmit-receive switch.

The apparatus can be configured to transmit simultaneously from all of the CMUT elements followed by reception of echo data by all of the CMUT elements. Alternatively, the apparatus can be configured to transmit from a selected one of the CMUT elements followed by reception of echo data by all of the CMUT elements. In this second approach, the apparatus can be configured to sequentially scan the selected one of the CMUT elements over part or all of the array of two or more CMUT elements.

The array of two or more CMUT elements can be a 1-D array (e.g., array 808 on FIG. 8C). The array two or more CMUT elements can also be a 3-D array, e.g., as shown on FIG. 8D. This shows a side view of several 2-D transducer arrays 812, 814 and 816 stacked onto an array substrate 810 to form a 3-D array.

As indicated above, the cavity of each CMUT element can be vented by one or more vias through the CMUT plate. Alternatively, the cavity of each CMUT element can be vented by one or more vias through the substrate.

The cavity of each CMUT element can be vented to an ambient. Alternatively, the cavity of each CMUT element can be vented to one or more pressure controllers, e.g., as shown on FIG. 1H. Such pressure controllers can be configured to control one or more CMUT parameters including but not limited to: gain and bandwidth.

1. Apparatus for ultrasonic sensing, the apparatus comprising:
an array of two or more Capacitive Micromachined Ultrasonic Transducer (CMUT) elements, wherein each CMUT element includes a CMUT plate suspended above a substrate with a cavity there between, and wherein the cavity of each CMUT element is vented;
wherein the array is configured such that each CMUT element operates both as a transmitter and as a receiver.

2. The apparatus of claim 1, wherein a fractional bandwidth of each CMUT element is 10% or more.

3. The apparatus of claim 1, further comprising a transmit-receive switch corresponding to each of the CMUT elements.

4. The apparatus of claim 1, wherein the apparatus is configured to transmit simultaneously from all of the CMUT elements followed by reception of echo data by all of the CMUT elements.

5. The apparatus of claim 1, wherein the apparatus is configured to transmit from a selected one of the CMUT elements followed by reception of echo data by all of the CMUT elements.

6. The apparatus of claim 5, wherein the apparatus is configured to sequentially scan the selected one of the CMUT elements over part or all of the array of two or more CMUT elements.

7. The apparatus of claim 1, wherein the array of two or more CMUT elements is a 1-D array.

8. The apparatus of claim 1, wherein the array of two or more CMUT elements is a 2-D array.

9. The apparatus of claim 1, wherein the array of two or more CMUT elements is a 3-D array.

10. The apparatus of claim 1, wherein the apparatus is configured for an application selected from the group consisting of: gesture sensors, proximity sensors, distance sensors, height sensors and facial recognition sensors.

11. The apparatus of claim 1, wherein the cavity of each CMUT element is vented by one or more vias through the CMUT plate.

12. The apparatus of claim 1, wherein the cavity of each CMUT element is vented by one or more vias through the substrate.

13. The apparatus of claim 1, wherein the cavity of each CMUT element is vented to an ambient.

14. The apparatus of claim 1, wherein the cavity of each CMUT element is vented to one or more pressure controllers.

15. The apparatus of claim 14, wherein the one or more pressure controllers are configured to control one or more CMUT parameters selected from the group consisting of: gain, and bandwidth.
